(19) United States
(12) Patent Application Publication
(10) Pub. No.: US 2020/0334668 A1
(43) Pub. Date: Oct. 22, 2020

(54) SYSTEM AND METHOD FOR CONTROLLING DIGITAL ASSETS

(71) Applicant: SICPA HOLDING SA, Prilly (CN)

(72) Inventors: Sauro NICLI, Morges (CH); Kalin NICOLOV, Nyon (CH); Adrien TRECCANI, Territet (CH); Cristina PEREIRO BARRUETA, Belmont-sur-Lausanne (CH)

(21) Appl. No.: 16/766,039

(22) PCT Filed: Nov. 21, 2018
(86) PCT No.: PCT/EP2018/082004

§ 371 Date: May 21, 2020

(30) Foreign Application Priority Data
Nov. 21, 2017 (EP) 17202900.1

(51) Int. Cl. G06Q 20/36; G06Q 20/06; G06Q 20/38; G06Q 20/42; G06Q 20/02

(52) U.S. Cl. CPC G06Q 20/3676; G06Q 20/0655; G06Q 20/3674; G06Q 20/027; G06Q 20/3829; G06Q 20/425; G06Q 20/3825

(57) ABSTRACT

Method and system of controlling by a control authority (2) emission or destruction of digital assets from a request received by an accredited ledger (8), so that the control authority can access to the ledger (8) for reading data stored therein. The request may relate to transfer registration of digital asset towards an account or between two accounts. Requests include stamp time and store and updated balance. In particular, the ledger (8) registers the transfer according to the received request by updating balances only in case the updated digital account balance of the account to be debited is positive.

### FIELD

The present disclosure relates to the field of control and generally teaches techniques related to distribution of digital asset to users.

### BACKGROUND

Digital assets can either be centralized, where there is a central point of control over the supply, or decentralized, where the control over the supply can come from various sources.

In a centralized scheme, there exists a control authority, e.g. a central bank, able to distribute digital assets, particularly, digital currency to users. The distribution can be performed via an operator (e.g. a bank or an ATM) running a gateway application.

The control authority concerns about risks and is in charge of regulating the amount of digital assents in circulation, considering digital asset emission and destruction. In particular, a control authority should ensure robustness of the account information and prevent fraud by facilitating full applicability of laws and regulations.

In this scheme, a particular risk relates to storage of digital assets. If some amount of digital asset is stored in a memory, and later, sub-amounts are distributed, a hacker access to the memory may cause the funds be diverted. In this regard, a ledger is the key since the ledger stores accounting information of a system across time.

### SUMMARY

The present invention was made in view of the situation described before.

An object of the present invention is to avoid illegitimate creation and storage of digital assets in advance implementing a control over asset distribution in real time.

As part of this approach, the invention also allows requests from users received on the fly.

Another object of the present invention is improving management of cash due to creation of liquidity on demand.

In particular, the invention enables the creation, distribution and revocation/destruction of digital assets, including but not limited to digital currency and digital legal tender, central bank issued digital currency, coupons and substitutes of value or claims against issuer liability in real time, eliminating the necessity to store by permitting instant fulfillment of market demand with real-time (on the fly) supply.

Further advantages and benefits of the invention are set out below:
Efficiency gains in currency distribution by allowing issuer and user to interact at a distance by digital means with marginal zero cost. For example, unlike traditional cash lifecycle, there would be no need to physically move cash from Central Bank to branches, or recover it for destruction, thus eliminating associated costs.
Security and efficiency gains by eliminating the need for stock/reserve storage of currency or claims against issuer liability. As a result, there would be no need for armed guards to secure storage facility.
Reduced risk during storage and distribution by eliminating the need to hold/transport large value physical currency. Consequently, the role of Cash-In-Transit companies is reduced.
Ability to quantify transaction-level information with varying degrees of privacy to feed decision and policy making. Privacy is a design feature and can be enforced to total privacy or full transparency.
Ability to have selective disclosure of information. For example, all transactions are anonymous unless court order decides to examine audit trail.
Designed to co-exist with and complement traditional forms of currency by extending functionality to online payment systems.
Ability to assign incentive structures to participants to align interests and enforce compliance models. For example, quota of gateway is incentive for gateway operator to distribute efficiently to ATMs.

A first particular aspect of the present invention concerns the control by a central authority (e.g. a central bank) of digital currency. This may be construed as an “open” system. In order to preserve stability and convertibility of money (and avoid inflation), it is necessary to strictly control that distribution of digital currency does not correspond to creation of artificial money (emission of credit). Of course, as part of monetary policy, the central bank can create money and/or credit (quantitative easing), but it is essential that this role/ability is limited to the central bank only.

If a user needs e-currency, he can approach, or access to, his commercial bank (operator) to request a transfer of digital currency on his account. In this case, the commercial bank is responsible before the central bank to allow this operation (because the user has changed some physical currency in an ATM to acquire digital currency, or the commercial bank accepts loans applications), and the amount of digital currency created in the user account should correspond to some charge on the commercial bank account.

If a user wants to transfer digital currency from his account to the account of another user, the central bank must be sure that the debtor account has sufficient digital currency to cover the payment so as to avoid creation of artificial e-money (i.e. of credit). In this case, the ledger that registers the operations is preferably a blockchain.

A second particular aspect of the present invention concerns a “closed” system in which the control authority (e.g. a company) distributes vouchers (or tokens) exchangeable for specific goods or services. In this case, fraud due to creation of artificial vouchers must be avoided.

In sum, the present invention aims at providing a method and a system capable of controlling by a control authority digital asset emission and/or digital asset destruction resulting from a request received by a ledger accredited to the control authority, so that the control authority can access to the ledger for reading data stored therein.

The request may relate to registration of a transfer of digital asset towards a first user digital account. The request may also relate to registration of a transfer of digital asset between this first user digital account and a second user digital account.

A digital account balance, indicated in the user digital account, is associated with the user in the ledger. The ledger stores data along with time stamps and also received requests and any account balance update. The ledger selectively registers the transfer of digital asset towards the user digital account according to the received request and updates the user digital account balance accordingly. The ledger also registers the transfer of digital asset between two users having their respective user digital accounts according to a received request and updates accordingly both user digital account balances, provided that the digital account balance of the user account to be debited remains positive after being updated.

Thus, the invention relates to a computer-implemented method of controlling by a control authority digital asset emission or digital asset destruction, comprising the steps of:
receiving, by a ledger accredited to the control authority, the ledger having processing and data storage capacities, a request for registering a transfer of digital asset towards a digital account of a first user corresponding to a first user identification number indicated in the request, or a request for registering a transfer of digital asset between the digital account of the first user and a digital account of a second user corresponding to a second user identification number further indicated in the request;
accessing and reading data stored in the ledger, wherein
   the first user digital account indicates a first user digital account balance, the first user digital account balance associated with the first user identification number being registered in the ledger;
   the second user digital account indicates a second user digital account balance, the second user digital account balance associated with the second user identification number being registered in the ledger;
processing a received request by the ledger, stamping time and storing the received request and any update of a user digital account balance; and
i) registering, by the ledger, the transfer of digital asset towards the first user digital account according to the received request by updating the first user digital account balance accordingly; and
ii) registering, by the ledger, the transfer of digital asset between the first user digital account and the second user digital account according to the received request by updating accordingly the first user digital account balance and the second user digital account balance only in case an updated digital account balance of the user account to be debited corresponds to a positive balance.

In a variant of the above method according to the invention,
the control authority has access to the ledger for transmitting and storing data in the ledger;
the request for registering the transfer of digital asset towards the first user digital account is sent by the first user to an operator accredited to the control authority, the operator sending the request received from the first user to the ledger via a gateway accredited to the control authority and having a gateway identification number, the gateway has a set of gateway parameters and a set of gateway rules validated by the control authority and applicable to the request sent via the gateway to the ledger, the gateway parameters indicating at least a maximal amount, or a maximal amount during a time period, of digital asset that can be requested via the gateway, and the set of gateway rules indicating rules applicable to digital asset emission and digital asset destruction resulting from any request transmitted via the gateway; the gateway identification number, the set of gateway parameters and the set of gateway rules being part of a gateway application program stored by the control authority into the ledger;
the control authority has a control authority identification number and stores in the ledger the identification number of the accredited gateway; and each one of the control authority, the first user and the gateway indicating its identification number in each data transfer; and
the ledger, further executes the gateway application program corresponding to the gateway identification number of the accredited gateway according to the request received from said gateway and to the corresponding set of gateway parameters and set of gateway rules for registering the transfer of digital asset to the first user digital account and updating the first user digital account balance accordingly, only in case the request is in further accordance with said set of gateway parameters, said set of gateway rules, and a gateway current state indicating the amount, or the amount during the time period, of digital asset already requested.

Moreover, the control authority may accredit a further gateway by the steps of:

a) assigning to the further gateway a further gateway identification number and a corresponding further gateway application program containing a set of further gateway parameters and a set of further gateway rules, the further gateway parameters indicating at least a maximal amount, or a maximal amount during a time period, of digital asset that can be requested via the further gateway, and the set of further gateway rules indicating rules applicable to digital asset emission and digital asset destruction resulting from any request transmitted via the further gateway; and

b) sending to the ledger, and storing in the ledger, the assigned further gateway identification number and the corresponding further gateway application program, thereby accrediting the further gateway.

In the above method according to the invention, each user identification number may be a user public key that is obtained by means of a digital signature algorithm from a corresponding user private key owned by the user.

Moreover, each user may generate a corresponding user digital signature by means of an application running on a user electronic device and using the digital signature algorithm, by entering its user private key into the user electronic device and obtaining said user digital signature, the user signing any request sent to the ledger with the obtained user digital signature, the ledger checking that a user digital signature on a received request has been validly generated from the corresponding received user public key by means of a user private key, thereby authenticating the received request; and, in case the user digital signature is not valid, the ledger prevents registering the transfer of digital asset specified in the request.

In the above-mentioned variant of the invention, and in case each user identification number is a user public key, the gateway identification number may be a gateway public key that is obtained by means of a digital signature algorithm from a corresponding gateway private key owned by the gateway.

Further, the gateway may generate a corresponding gateway digital signature by means of a gateway application and using the digital signature algorithm, by running the gateway application with the gateway private key and obtaining said gateway digital signature, the gateway signing any request sent to the ledger with the obtained gateway digital signature, the ledger checking that a gateway digital signature on a received request has been validly generated from the corresponding received gateway public key by means of a gateway private key, thereby authenticating the received request; and, in case the gateway digital signature is not valid, the ledger prevents registering the transfer of digital asset specified in the request and updating the corresponding user digital asset balance.

Moreover, the method may further involve a control unit accredited to the control authority and having a control unit identification number, the control unit accessing to the ledger and reading any stored request sent by a gateway and the corresponding stored gateway application program, the control unit indicating its identification number in each data transfer to the ledger, the control unit detecting in a request from a gateway stored in the ledger whether a security rule regarding transmission of request has been infringed by said gateway and, in case of infringement, storing into the ledger a security alert message containing the gateway identification number of the infringing gateway; and the ledger, upon reception of a request from a gateway, checking whether a stored security alert message indicates that a gateway identification number corresponding to said gateway is an infringing gateway, and preventing any registering operation relating to a request sent by an infringing gateway.

According to another aspect, the invention relates to a system for controlling by a control authority digital asset emission or digital asset destruction, the system comprising one or more processors and memory storing instructions, wherein the one or more processors are configured to execute the instructions such that the processor and memory are configured to
receive, by a ledger accredited to the control authority, the ledger having processing and data storage capacities, a request for registering a transfer of digital asset towards a digital account of a first user corresponding to a first user identification number indicated in the request, or a request for registering a transfer of digital asset between the digital account of the first user and a digital account of a second user corresponding to a second user identification number further indicated in the request;
access and read data stored in the ledger, wherein
   the first user digital account indicates a first user digital account balance, the first user digital account balance associated with the first user identification number being registered in the ledger;
   the second user digital account indicates a second user digital account balance, the second user digital account balance associated with the second user identification number being registered in the ledger;
process a received request by the ledger, stamp time and store the received request and any update of a user digital account balance; and

i) register, by the ledger (8), the transfer of digital asset towards the first user digital account according to the received request by updating the first user digital account balance accordingly; and

ii) register, by the ledger (8), the transfer of digital asset between the first user digital account and the second user digital account according to the received request by updating accordingly the first user digital account balance and the second user digital account balance only in case an updated digital account balance of the user account to be debited corresponds to a positive balance.

In a variant of the above system according to the invention,
the control authority has access to the ledger via the communication network for transmitting and storing data in the ledger;
the request for registering the transfer of digital asset towards the first user digital account is sent by the first user to an operator accredited to the control authority, the operator sending the request received from the first user to the ledger via a gateway accredited to the control authority and having a gateway identification number, the gateway has a set of gateway parameters and a set of gateway rules validated by the control authority and applicable to the request sent via the gateway to the ledger, the gateway parameters indicating at least a maximal amount, or a maximal amount during a time period, of digital asset that can be requested via the gateway, and the set of gateway rules indicating rules applicable to digital asset emission and digital asset destruction resulting from any request transmitted via the gateway; the gateway identification number, the set of gateway parameters and the set of gateway rules being part of a gateway application program stored by the control authority into the ledger;
the control authority has a control authority identification number and stores in the ledger the identification number of the accredited gateway; and each one of the control authority, the first user and the gateway indicating its identification number in each data transfer;
the ledger, is further operable to execute the stored gateway application program corresponding to the gateway identification number of the accredited gateway according to the request received from said gateway and to the corresponding set of gateway parameters and set of gateway rules for registering the transfer of digital asset to the first user digital account and updating the first user digital account balance accordingly, only in case the request is in further accordance with said set of gateway parameters, said set of gateway rules, and a gateway current state indicating the amount, or the amount during the time period, of digital asset already requested.

Moreover, the gateway may be operable to run on an Automated Teller Machine (ATM) or a smartphone or a tablet or a Web interface.

In the system according to the above-mentioned variant, the control authority may be operable to accredit a further gateway by:

a) assigning to the further gateway a further gateway identification number and a corresponding further gateway application program containing a set of further gateway parameters and a set of further gateway rules, the further gateway parameters indicating at least a maximal amount, or a maximal amount during a time period, of digital asset that can be requested via the further gateway, and the set of further gateway rules indicating rules applicable to digital asset emission and digital asset destruction resulting from any request transmitted via the further gateway; and

b) sending to the ledger via the communication network, and storing in the ledger, the assigned further gateway identification number and the corresponding further gateway application program, thereby accrediting the further gateway.

In the System according to the invention, each user identification number may be a user public key obtained from a corresponding user private key owned by the user by means of a corresponding user identifying device having processing capabilities and having installed a programmed digital signature algorithm operable to provide said user public key upon entering in the user identifying device, and processing, said user private key.

Moreover, each user may generate a corresponding user digital signature by means of an application running on a user electronic device and using the digital signature algorithm, by entering its user private key into the user electronic device and obtaining said user digital signature, the user signing any request sent to the ledger with the obtained user digital signature, the ledger being operable to check that a user digital signature on a received request has been validly generated from the corresponding received user public key by means of a user private key, thereby authenticating the received request.

In the system according to the above-mentioned variant, and in case each user identification number is a user public key, the gateway identification number may be a gateway public key that is obtained by means of a digital signature algorithm from a corresponding gateway private key owned by the gateway.

Moreover, the gateway may be operable to generate a corresponding gateway digital signature by means of a gateway application and using the digital signature algorithm, by running the gateway application with the gateway private key and obtaining said gateway digital signature, the gateway being operable to sign any request sent to the ledger with the obtained gateway digital signature, the ledger being operable to check that a gateway digital signature on a received request has been validly generated from the corresponding received gateway public key by means of a gateway private key, thereby authenticating the received request; and, in case the gateway digital signature is not valid, the ledger is operable to prevent registering the transfer of digital asset specified in the request and updating the corresponding user digital asset balance.

The above system according to the invention may further involve a control unit accredited to the control authority and having a control unit identification number,
the control unit being operable to access to the ledger via a control communication link and read any stored request sent by a gateway and the corresponding stored gateway application program, the control unit indicating its identification number in each data transfer to the ledger, the control unit being operable to detect in a request from a gateway stored in the ledger whether a security rule regarding transmission of request has been infringed by said gateway and, in case of infringement, store into the ledger a security alert message containing the gateway identification number of the infringing gateway; and
the ledger, upon reception of a request from a gateway, being operable to check whether a stored security alert message indicates that a gateway identification number corresponding to said gateway is an infringing gateway, and being operable to prevent any registering operation and updating of the corresponding user digital account balance relating to a request sent by an infringing gateway.

In the system according to the invention, each user may have a corresponding user digital wallet, corresponding to the user identification number, operable to be connected to the ledger by sending to the ledger a connection message containing the user identification number, and read the corresponding user digital account balance stored in the ledger and update a digital asset amount in the wallet based on the read digital account balance.

### BRIEF DESCRIPTION OF THE DRAWINGS

A series of drawings, which aid in better understanding the disclosure and which are presented as non-limiting examples, are very briefly described below.

FIG. 1 illustrates a high-level block diagram of an open system architecture.

FIG. 2 illustrates a high-level block diagram of a closed system architecture.

### DETAILED DESCRIPTION

The present disclosure is here described in detail with reference to non-limiting embodiments illustrated in the drawings.

Firstly, brief definitions of terms, abbreviations and concepts used throughout this application are given below.

### Terminology

Control Unit—Machine or otherwise automated control function allowing the access, reading and analysis of data from the ledger to generate sufficient data set for pattern deviation identification, reporting and execution of logic.

Ledger—A ledger is a database storing the accounting information of a system across time. It may be under the control of a central authority, or distributed to multiple maintainers. The most widely known distributed ledgers are the bitcoin blockchain and ethereum blockchain. The mechanism through which maintainers agree on the evolution of the ledger is called consensus algorithm: it may be very different from one ledger implementation to another. A ledger may also offer a secure environment to execute applications impacting the accounting, also called smart contracts. In its simplest form, a ledger is simply a list of account numbers with balances. More advanced ledgers store all transactions, all balances, and include cryptographic proofs of integrity. Modern ledgers rely on cryptography to allow for the dynamic creation of new accounts or smart contracts by the end-users directly: end-users may then prove ownership and execute transfer with a secret key without revealing their legal identity. The content of the ledger itself might, or might not, show the legal identity of account owners. The data could even be encrypted to hide the balances, the transactions, or any information. The ledger generally exposes an authenticated API to interact with it, e.g., to order a transfer, execute a smart contract, or read account details.

Wallet—A wallet is an application specialized in storing digital currencies. Its main feature is to securely store a secret key and use it to order authenticated requests to the ledger API. For instance, the secret key may be used to order a transfer to be executed by the ledger. The wallet may show the balance of an account (or multiple accounts), the transaction history, the account number (also known as address) to receive funds, and any other information stored by the ledger or by the wallet itself. The wallet fetches information from the ledger API, some of which being free access, other being authenticated. Authenticated operations, such as ordering a transfer, require the approval of the owner using the secret key stored by the wallet: in most cases, it takes the form of a digital signature.

Smart contract—A smart contract is an application executed in the ledger environment, which may secure funds with a programmable logic. It offers strong guarantees that the application might not be modified once it has been published, and that the funds it stores on the ledger may only be accessed through its logic. It may be used to create a multi-signature account, which requires multiple secret keys to unlock a deposit.

Application programming interface (API)—An API is a set of subroutine definitions, protocols, and tools for building application software. In general terms, it is a set of clearly defined methods of communication between various software components. API makes it easier to develop a computer program by providing all the building blocks to be put together by programmers.

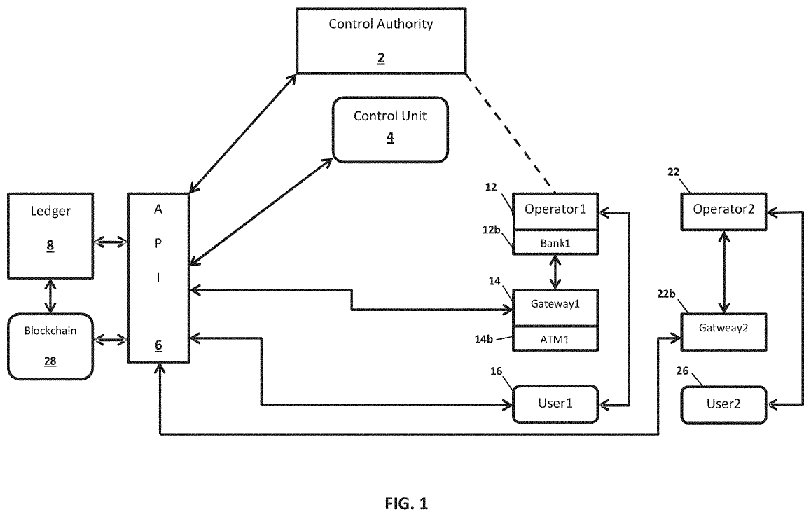

FIG. 1 is a block diagram depicting an architecture overview of the system. A control authority 2 (e.g. a Central Bank) is responsible of managing digital assets in a secure way. Especially, in respect of the issuance policy (i.e., liquidity injection) and the storage of reserves or the amount of digital assets in circulation at every moment. The control authority 2 monitors compliance with particular rules. The role of the control authority 2 and control unit 4 will be illustrated in more detail later. A ledger 8 is distributed database shared across a network of multiple entities, each having an identical copy of the records. Interactions among entities are directed by a consensus algorithm that regulates how to reach agreement on accounting. To control who can do what, security and integrity of digital assets stored in the ledger are maintained using cryptography techniques. Enabled transactions are aggregated in ‘blocks’ so these can be added to a ‘chain’ of existing blocks using a cryptographic signature.

Operators 12, 32 may exchange digital assets that are safeguarded by the ledger 6. The operator 12 may be in some embodiments a commercial bank or an ATM having capability of receiving banknotes, transferring digital asset and registering transactions. The operator 12 manages the bank account of a first user 16 and an ATM 14b having a first gateway 14. The first user 16 can send a request to the operator 12 for receiving digital asset on a first user account (if the operator 12 agrees). The first user 16 can also send a request for registering a transfer towards another account of a user 26. The request is sent to the ledger 8 through the interface API 6.

Example of a User-to-User Transaction:

A first user 16 creates a data structure containing transaction-related information, such as the receivers account, the sender's account, the amount to transfer, and a digital signature with the first user's private key to authorize the transaction. Said data structure forms part of a request.

The first user 16 using an electronic device may send a request to the API 6 using a standard encoding (e.g., JSON) and communication channel (e.g., HTTP or RPC). The API 6 verifies the format of the request and forwards the data structure to the processing unit of the ledger 8.

The processing unit of ledger 8 formally verifies the request, including the validity of the signatures, and updates the database of the ledger 8 accordingly by effectively subtracting the amount from the senders account and crediting the receivers account.

The state of the ledger 8 may be validated and confirmed in a blockchain 28 ensuring data integrity and immutability.

Optionally, the processing unit of the ledger 8 may notify the receiver of the incoming transaction (second user 26). For instance, via implementation of push notification services or equivalent that enable third party application developers to send notification data to applications installed on compatible devices (e.g. Apple push notification services).

Example of Issuance

A user 16, 26 using an electronic device contacts an operator 12, 22 through an interface to request a digital asset issuance (e.g., e-banking platform, or a bank ATM exchange with cash).

The operator 12 assesses the validity of users request and employs its associated gateway 14 to generate a data structure corresponding to an issuance request, including the amount to issue, the destination account, the gateway identifier, and a digital signature using the gateway's private key.

The operator 12 sends the data structure to the API using a standard encoding (e.g., JSON) and communication channel (e.g., HTTP or RPC).

The API 6 verifies the format of the request and forwards the data structure to the processing unit of the ledger 8.

The processing unit of the ledger 8 formally verifies the issuance request including the validity of the signature. Then the database of ledger 8 is updated by effectively crediting the receivers account and updating the state (e.g., the remaining quota) of the gateway 14.

The state of the ledger 8 may be validated and confirmed in a blockchain 28 ensuring data integrity and immutability.

Optionally, the processing unit of ledger 8 may notify the receiver of the incoming transaction through a push notification.

Smart Contract Creation

A user develops a smart contract. This can be done by using a supported programming language like Ethereum low-level language (see github.com/ethereum/wiki/wiki/White-Paper#code-execution) or higher-level languages like Solidity (see solidity.readthedocs.io).

At any event, the programming language is used to describe a self-contained software with an interface that may be protected with access rights. In some cases, certain features of a smart contract may also require a digital signature corresponding to a specific public key.

The user 16 with appropriate tools may build a data structure containing the contract code (in other occasions, the contract may be compiled), the user identification like his account number and a digital signature to prove the user identity.

The user 16 sends the data structure to the API 6 using a standard encoding (e.g., JSON) and communication channel (e.g., HTTP or RPC).

The API 6 verifies the format of the request and forwards the data structure to the business layer.

The processing unit of the ledger 8 formally verifies the contract creation request, including the validity of the signature, and updates the database of the ledger 8 accordingly by effectively inserting the contract in the database and assigning a contract identifier.

Optionally, the processing unit of the ledger 8 notifies the user 16 of the contract creation along with the contract identifier through a push notification.

The user 16 or another user may create a data structure to execute an application of the smart contract, which may contain a contract identifier, operations to execute, possible parameters, and the signature of the user.

The user 16 or another user sends the data structure to the API 6 using a standard encoding (e.g., JSON) and communication channel (e.g., HTTP or RPC)

The API 6 verifies the format of the request and forwards the data structure to the processing unit of the ledger 8.

The processing unit of the ledger 8 formally verifies the contract call request, including the validity of the signature. The processing unit of the ledger 8 also updates the database of the ledger 8 by effectively executing the contract's operations in the ledger 8 and may update the state of the ledger 8 as well. Optionally, the processing unit of the ledger 8 may notify the user 16 responsible of the contract creation and of the contract identifier through a push notification as mentioned in other examples.

Referring back to the control authority 2 and the control unit 4, several situations are presented below to better illustrate their functionalities.

For example, a rule is implemented so no user may make any payment over 100 units (unit may be euro, dollar, or other currency asset etc.). The control unit 4 observes rules compliance. Thus, if random user performs 3 payments of 50 units each in a short period of time, these payments will be tracked chronologically, aggregated and flagged as total of 150 exceeding the 100 unit limitation.

In this regard, the control unit 4 may implement machine-learning techniques allowing it to discern with high degree of certainty between normal and abnormal pattern deviation.

For example, in a retail store is considered normal within the average deviation that jackets be sold priced at 50 units, whereas transactions of non-store recipient of multiple 50 units will be flagged for fraud.

For example, in some embodiments, a central bank or an issuer authority may act as a control authority 2 to issue, circulate and destroy legal tender in digital form. Said control authority 2 can assign roles that fit current financial system to operate with a narrow money supply (MI). In minimal mode, the control authority 2, control unit 4, gateway 14, operator 12 and ATM 14b may be collapsed and their tasks be performed exclusively by the control authority 2.

In some embodiments, a central bank or an issuer authority can behave like a control authority 2, whereas commercial banks can work as gateways 14, 24 and/or operators 12, 22. Commercial banks can manage single or multiple ATMs serving digital legal tender to users. Users 16, 26 can be both companies and individuals operating within the currency issued by the control authority 2. On the other hand, regulatory agencies can take the role of a control unit 4 and thus, oversee the compliance of the system.

In some preferred embodiments, a central bank may be geographically distributed but running a centrally-controlled ledger 8 to store the current state of accounts in currency and execute in real time. The control unit 4 may be a separate entity, supervising activities. Gateways 14, 16 may be commercial entities, for example commercial banks or other financial actors (credit, loan, broad money space institutions, etc.). ATMs 14b, 24b can be liquidity access points with controlled or open access, for example current cash-in-transit and automatic teller machine operators.

In addition, the system may preferably operate in identical fashion to cash banknotes and coins, offering privacy across the entire system. In the event of a malicious behavior (e.g. crime), the control unit 4 or another entity mandated by the control authority 2 can flag transactions or set of transactions for investigation while preserving the overall privacy of system participants. This allows transparency on actors involved in flagged transactions.

Compared to traditional banknotes and coins, legal tender and other bearer instruments, a digital legal tender issued by a control authority 2 (e.g. a Central Bank) offers significant efficiencies. Entire lifecycle of its existence can benefit from this approach, from production, storage, security costs, and distribution to the use of narrow money (MI) in monetary policy.

In the production stage, the digital legal tender collapses the long lead times of design, sourcing, production and storage allowing the control authority 2 to issue liquidity in the matter of hours, compared to months in traditional setup. Efficiencies in storage, security costs and distribution are achieved by meeting market demand for liquidity by offering such on demand, in real time thus eliminating the need to store large amounts in limited points of presence (vaults, high security production facilities and printing works).

The present proposal advantageously eliminates the need for stock by serving a continuous flow of narrow money on demand (stock vs flow). The programmable logic applied to the system is enforcing supply side rules related to quantity accessible by the demand side: this balance is essential for the effectiveness of monetary policy in a hybrid environment where traditional and digital legal tender co-exist and complement each other in functionality. Liquidity in the form of digital legal tender is both delivered and retracted from the market, serving the need of tightly controlled supply side rules.

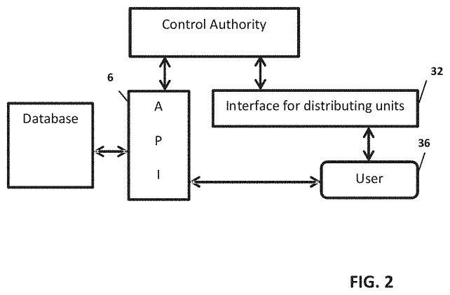

FIG. 2 illustrates a second scenario of a “closed system” that permits an entity (business, corporation, government, venue or person) to securely issue in digital form certain units of exchange, including but not limited to private currencies, tokenized items, digital commodities, electronic gaming items, vouchers and other digital assets.

An entity acting as control authority 2 can design an issuance model as incentive (e.g. airline miles), time-based (e.g. interest-earning every week/month/year) or otherwise.

An interface for distributing units 32 supervised by the control authority 2 may provide users with units. A user 36 using an electronic device may acquire circulating units.

The control authority 2 may permit higher supply of units, as well as the retraction model (destruction) where upon use or claim of liability, a unit is destroyed and removed from circulation (e.g. referral program tokens used for cinema entry are destroyed at time of entry instead of stored and circulated anew).

In a most preferred mode, the system can extend functionality to generate, circulate and destroy concurrently multiple units of exchange, including derivatives and aggregated items (e.g. basket of units). In the context of a closed system (e.g. mall or airport), the control authority 2 may issue multiple types of units for varying needs (e.g. tokens for accessing entertainment, reward for spending above certain threshold, time-based parking allowance, etc.).

1. A computer-implemented method of controlling by a control authority digital asset emission or digital asset destruction, comprising the steps of:
receiving, by a ledger accredited to the control authority, the ledger having processing and data storage capacities, a request for registering a transfer of digital asset towards a digital account of a first user corresponding to a first user identification number indicated in the request, or a request for registering a transfer of digital asset between the digital account of the first user and a digital account of a second user corresponding to a second user identification number further indicated in the request;
accessing and reading data stored in the ledger, wherein
the first user digital account indicates a first user digital account balance, the first user digital account balance associated with the first user identification number being registered in the ledger; the second user digital account indicates a second user digital account balance, the second user digital account balance associated with the second user identification number being registered in the ledger;
processing a received request by the ledger, stamping time and storing the received request and any update of a user digital account balance; and
i) registering, by the ledger, the transfer of digital asset towards the first user digital account according to the received request by updating the first user digital account balance accordingly; and
ii) registering, by the ledger, the transfer of digital asset between the first user digital account and the second user digital account according to the received request by updating accordingly the first user digital account balance and the second user digital account balance only in case an updated digital account balance of the user account to be debited corresponds to a positive balance.

2. The method according to claim 1, wherein
the control authority has access to the ledger for transmitting and storing data in the ledger;
the request for registering the transfer of digital asset towards the first user digital account is sent by the first user to an operator accredited to the control authority, the operator sending the request received from the first user to the ledger via a gateway accredited to the control authority and having a gateway identification number, the gateway has a set of gateway parameters and a set of gateway rules validated by the control authority and applicable to the request sent via the gateway to the ledger, the gateway parameters indicating at least a maximal amount, or a maximal amount during a time period, of digital asset that can be requested via the gateway, and the set of gateway rules indicating rules applicable to digital asset emission and digital asset destruction resulting from any request transmitted via the gateway; the gateway identification number, the set of gateway parameters and the set of gateway rules being part of a gateway application program stored by the control authority into the ledger;
the control authority has a control authority identification number and stores in the ledger the identification number of the accredited gateway; and each one of the control authority, the first user and the gateway indicating its identification number in each data transfer; and
the ledger, further executes the gateway application program corresponding to the gateway identification number of the accredited gateway according to the request received from said gateway and to the corresponding set of gateway parameters and set of gateway rules for registering the transfer of digital asset to the first user digital account and updating the first user digital account balance accordingly, only in case the request is in further accordance with said set of gateway parameters, said set of gateway rules, and a gateway current state indicating the amount, or the amount during the time period, of digital asset already requested.

3. The method according to claim 2, wherein the control authority accredits a further gateway by the steps of:
a) assigning to the further gateway a further gateway identification number and a corresponding further gateway application program containing a set of further gateway parameters and a set of further gateway rules, the further gateway parameters indicating at least a maximal amount, or a maximal amount during a time period, of digital asset that can be requested via the further gateway, and the set of further gateway rules indicating rules applicable to digital asset emission and digital asset destruction resulting from any request transmitted via the further gateway; and
b) sending to the ledger, and storing in the ledger, the assigned further gateway identification number and the corresponding further gateway application program, thereby accrediting the further gateway.

4. The method according to claim 1, wherein each user identification number is a user public key that is obtained by means of a digital signature algorithm from a corresponding user private key owned by the user.

5. The method according to claim 4, wherein each user generates a corresponding user digital signature by means of an application running on a user electronic device and using the digital signature algorithm, by entering its user private key into the user electronic device and obtaining said user digital signature, the user signing any request sent to the ledger with the obtained user digital signature, the ledger checking that a user digital signature on a received request has been validly generated from the corresponding received user public key by means of a user private key, thereby authenticating the received request; and, in case the user digital signature is not valid, the ledger prevents registering the transfer of digital asset specified in the request.

6. The method according to claim 2, wherein each user identification number is a user public key that is obtained by means of a digital signature algorithm from a corresponding user private key owned by the user, and wherein the gateway identification number is a gateway public key that is obtained by means of a digital signature algorithm from a corresponding gateway private key owned by the gateway.

7. The method according to claim 6, wherein the gateway generates a corresponding gateway digital signature by means of a gateway application and using the digital signature algorithm, by running the gateway application with the gateway private key and obtaining said gateway digital signature, the gateway signing any request sent to the ledger with the obtained gateway signature, the ledger checking that a gateway digital signature on a received request has been validly generated from the corresponding received gateway public key by means of a gateway private key, thereby authenticating the received request; and, in case the gateway digital signature is not valid, the ledger prevents registering the transfer of digital asset specified in the request and updating the corresponding user digital asset balance.

8. The method according to claim 2, wherein
a control unit accredited to the control authority and having a control unit identification number, the control unit accessing to the ledger and reading any stored request sent by a gateway and the corresponding stored gateway application program, the control unit indicating its identification number in each data transfer to the ledger, the control unit detecting in a request from a gateway stored in the ledger whether a security rule regarding transmission of request has been infringed by said gateway and, in case of infringement, storing into the ledger a security alert message containing the gateway identification number of the infringing gateway;
the ledger, upon reception of a request from a gateway, checking whether a stored security alert message indicates that a gateway identification number corresponding to said gateway is an infringing gateway, and preventing any registering operation relating to a request sent by an infringing gateway.

9. A system for controlling by a control authority digital asset emission or digital asset destruction, the system comprising one or more processors and memory storing instructions, wherein the one or more processors are configured to execute the instructions such that the processor and memory are configured to
receive, by a ledger accredited to the control authority, the ledger having processing and data storage capacities, a request for registering a transfer of digital asset towards a digital account of a first user corresponding to a first user identification number indicated in the request, or a request for registering a transfer of digital asset between the digital account of the first user and a digital account of a second user corresponding to a second user identification number further indicated in the request;
access and read data stored in the ledger, wherein
the first user digital account indicates a first user digital account balance, the first user digital account balance associated with the first user identification number being registered in the ledger;
the second user digital account indicates a second user digital account balance, the second user digital account balance associated with the second user identification number being registered in the ledger;
process a received request by the ledger, stamp time and store the received request and any update of a user digital account balance; and
i) register, by the ledger, the transfer of digital asset towards the first user digital account according to the received request by updating the first user digital account balance accordingly; and
ii) register, by the ledger, the transfer of digital asset between the first user digital account and the second user digital account according to the received request by updating accordingly the first user digital account balance and the second user digital account balance only in case an updated digital account balance of the user account to be debited corresponds to a positive balance.

10. The system according to claim 9, wherein
the control authority has access to the ledger via the communication network for transmitting and storing data in the ledger;
the request for registering the transfer of digital asset towards the first user digital account is sent by the first user to an operator accredited to the control authority, the operator sending the request received from the first user to the ledger via a gateway accredited to the control authority and having a gateway identification number, the gateway has a set of gateway parameters and a set of gateway rules validated by the control authority and applicable to the request sent via the gateway to the ledger, the gateway parameters indicating at least a maximal amount, or a maximal amount during a time period, of digital asset that can be requested via the gateway, and the set of gateway rules indicating rules applicable to digital asset emission and digital asset destruction resulting from any request transmitted via the gateway; the gateway identification number, the set of gateway parameters and the set of gateway rules being part of a gateway application program stored by the control authority into the ledger;
the control authority has a control authority identification number and stores in the ledger the identification number of the accredited gateway; and each one of the control authority, the first user and the gateway indicating its identification number in each data transfer;
the ledger, is further operable to execute the stored gateway application program corresponding to the gateway identification number of the accredited gateway according to the request received from said gateway and to the corresponding set of gateway parameters and set of gateway rules for registering the transfer of digital asset to the first user digital account and updating the first user digital account balance accordingly, only in case the request is in further accordance with said set of gateway parameters, said set of gateway rules, and a gateway current state indicating the amount, or the amount during the time period, of digital asset already requested.

11. The system according to claim 10, wherein the gateway is operable to run on an Automated Teller Machine or a smartphone or a tablet or a Web interface.

12. The system according to claim 10, wherein the control authority is operable to accredit a further gateway by:
a) assigning to the further gateway a further gateway identification number and a corresponding further gateway application program containing a set of further gateway parameters and a set of further gateway rules, the further gateway parameters indicating at least a maximal amount, or a maximal amount during a time period, of digital asset that can be requested via the further gateway, and the set of further gateway rules indicating rules applicable to digital asset emission and digital asset destruction resulting from any request transmitted via the further gateway; and
b) sending to the ledger via the communication network, and storing in the ledger, the assigned further gateway identification number and the corresponding further gateway application program,
thereby accrediting the further gateway.

13. The system according to claim 9, wherein each user identification number is a user public key obtained from a corresponding user private key owned by the user by means of a corresponding user identifying device having processing capabilities and having installed a programmed digital signature algorithm operable to provide said user public key upon entering in the user identifying device, and processing, said user private key.

14. The system according to claim 13, wherein each user can generate a corresponding user digital signature by means of an application running on a user electronic device and using the digital signature algorithm, by entering its user private key into the user electronic device and obtaining said user digital signature, the user signing any request sent to the ledger with the obtained user digital signature, the ledger being operable to check that a user digital signature on a received request has been validly generated from the corresponding received user public key by means of a user private key, thereby authenticating the received request.

15. The system according to claim 10,
wherein each user identification number is a user public key obtained from a corresponding user private key owned by the user by means of a corresponding user identifying device having processing capabilities and having installed a programmed digital signature algorithm operable to provide said user public key upon entering in the user identifying device, and processing, said user private key, and
wherein the gateway identification number is a gateway public key that is obtained by means of a digital signature algorithm from a corresponding gateway private key owned by the gateway.

16. The system according to claim 15, wherein the gateway is operable to generate a corresponding gateway digital signature by means of a gateway application and using the digital signature algorithm, by running the gateway application with the gateway private key and obtaining said gateway digital signature, the gateway being operable to sign any request sent to the ledger with the obtained gateway digital signature, the ledger being operable to check that a gateway digital signature on a received request has been validly generated from the corresponding received gateway public key by means of a gateway private key, thereby authenticating the received request; and, in case the gateway digital signature is not valid, the ledger is operable to prevent registering the transfer of digital asset specified in the request and updating the corresponding user digital asset balance.

17. The system according to claim 10, wherein
a control unit accredited to the control authority and having a control unit identification number, the control unit being operable to access to the ledger via a control communication link and read any stored request sent by a gateway and the corresponding stored gateway application program, the control unit indicating its identification number in each data transfer to the ledger, the control unit being operable to detect in a request from a gateway stored in the ledger whether a security rule regarding transmission of request has been infringed by said gateway and, in case of infringement, store into the ledger a security alert message containing the gateway identification number of the infringing gateway; and
the ledger, upon reception of a request from a gateway, being operable to check whether a stored security alert message indicates that a gateway identification number corresponding to said gateway is an infringing gateway, and being operable to prevent any registering operation and updating of the corresponding user digital account balance relating to a request sent by an infringing gateway.

18. The system according to claim 9, wherein
each user has a corresponding user digital wallet, corresponding to the user identification number, operable to be connected to the ledger by sending to the ledger a connection message containing the user identification number, and read the corresponding user digital account balance stored in the ledger and update a digital asset amount in the wallet based on the read digital account balance.
